(19) United States
(12) Patent Application Publication
(10) Pub. No.: US 2020/0249447 A1
(43) Pub. Date: Aug. 6, 2020

(54) CAMERA MODULE AND ELECTRONIC DEVICE

(71) Applicant: LARGAN PRECISION CO., LTD., Taichung City (TW)

(72) Inventors: Shih-Han CHEN, Taichung City (TW); Lin-An CHANG, Taichung City (TW); Ming-Ta CHOU, Taichung City (TW)

(21) Appl. No.: 16/589,253

(22) Filed: Oct. 1, 2019

(30) Foreign Application Priority Data
Feb. 1, 2019 (TW) 108201795

(51) Int. Cl. G02B 13/00; G02B 9/60; H04N 5/262; H04N 5/225

(52) U.S. Cl. CPC G02B 13/0075; G02B 9/60; H04N 5/2254; H04N 5/2621; G02B 13/0045

(57) ABSTRACT

A camera module includes an imaging lens assembly and an image sensor. An image is formed on the image sensor via the imaging lens assembly, the image sensor is disposed on an image side of the imaging lens assembly, and the imaging lens assembly includes a lens barrel, a plurality of plastic lens elements and a first light blocking sheet. The plastic lens elements are disposed in the lens barrel. The first light blocking sheet is disposed in the lens barrel and has a non-circular opening. A portion of the image formed via the imaging lens assembly is a defocused image, and a shape of at least one portion of the defocused image is non-circular and corresponding to a shape of the non-circular opening of the first light blocking sheet.

### RELATED APPLICATIONS

This application claims priority to Taiwan Application Serial Number 108201795, filed Feb. 1, 2019, which is herein incorporated by reference.

### BACKGROUND

### Technical Field

The present disclosure relates to a camera module and an electronic device. More particularly, the present disclosure relates to a camera module with compact size applicable to an electronic device.

### Description of Related Art

With recent technology of semiconductor process advances, performances of image sensors are enhanced, so that the smaller pixel size can be achieved. Therefore, camera modules with high image quality and imaging lens assemblies thereof have become an indispensable part of many modern electronics.

With rapid developments of technology, applications of electronic devices equipped with camera modules increase and there is a wide variety of requirements for camera modules and imaging lens assemblies thereof. However, in a conventional camera modules and imaging lens assemblies thereof, it is hard to balance among image quality, aperture size, volume, field of view or special effect. Thus, there is a demand for a camera module and imaging lens assembly thereof that meet the aforementioned needs.

### SUMMARY

According to one aspect of the present disclosure, a camera module includes an imaging lens assembly and an image sensor. An image is formed on the image sensor via the imaging lens assembly, the image sensor is disposed on an image side of the imaging lens assembly, and the imaging lens assembly includes a lens barrel, a plurality of plastic lens elements and a first light blocking sheet. The plastic lens elements are disposed in the lens barrel. The first light blocking sheet is disposed in the lens barrel and has a non-circular opening. A portion of the image formed via the imaging lens assembly is a defocused image, and a shape of at least one portion of the defocused image is non-circular and corresponding to a shape of the non-circular opening of the first light blocking sheet.

According to another aspect of the present disclosure, an electronic device includes two camera modules. The two camera modules are disposed towards a same side of the electronic device, and each of the camera modules includes an imaging lens assembly and an image sensor. An image is formed on the image sensor via the imaging lens assembly of each of the camera modules, and the image sensor is disposed on an image side of the imaging lens assembly of each of the camera modules. At least one of the two imaging lens assemblies includes a lens barrel, a plurality of plastic lens elements and a first light blocking sheet. The plastic lens elements are disposed in the lens barrel. The first light blocking sheet is disposed in the lens barrel and has a non-circular opening. A portion of the image formed via the at least one of the two imaging lens assemblies is a defocused image, a shape of at least one portion of the defocused image is non-circular and corresponding to a shape of the non-circular opening of the first light blocking sheet.

### BRIEF DESCRIPTION OF THE DRAWINGS

The present disclosure can be more fully understood by reading the following detailed description of the embodiment, with reference made to the accompanying drawings as follows:

FIG. 1A is an exploded view of a camera module according to a 1st embodiment of the present disclosure.

FIG. 1B is a schematic view of an imaging lens assembly of the camera module according to the 1st embodiment.

FIG. 1C is a schematic view of a first light blocking sheet of the camera module according to the 1st embodiment.

FIG. 1D is a schematic view of a using state of the camera module according to the 1st embodiment.

FIG. 1E is a schematic view of the image captured via the camera module according to the 1st embodiment.

FIG. 1F is a schematic view of the non-circular opening of the first light blocking sheet according to the 1st embodiment.

FIG. 1G is a schematic view of the non-circular opening of the first light blocking sheet according to the 1st embodiment.

FIG. 2 is a schematic view of a camera module according to a 2nd embodiment of the present disclosure.

FIG. 3A is an exploded view of a camera module according to a 3rd embodiment of the present disclosure.

FIG. 3B is a schematic view of the camera module according to the 3rd embodiment.

FIG. 4A is a schematic view of an electronic device according to a 4th embodiment of the present disclosure.

FIG. 4B is another schematic view of the electronic device according to the 4th embodiment.

FIG. 5A is a schematic view of a light blocking sheet of a camera module of prior art.

FIG. 5B is a schematic view of an image captured via the camera module of prior art.

### DETAILED DESCRIPTION

### 1st Embodiment

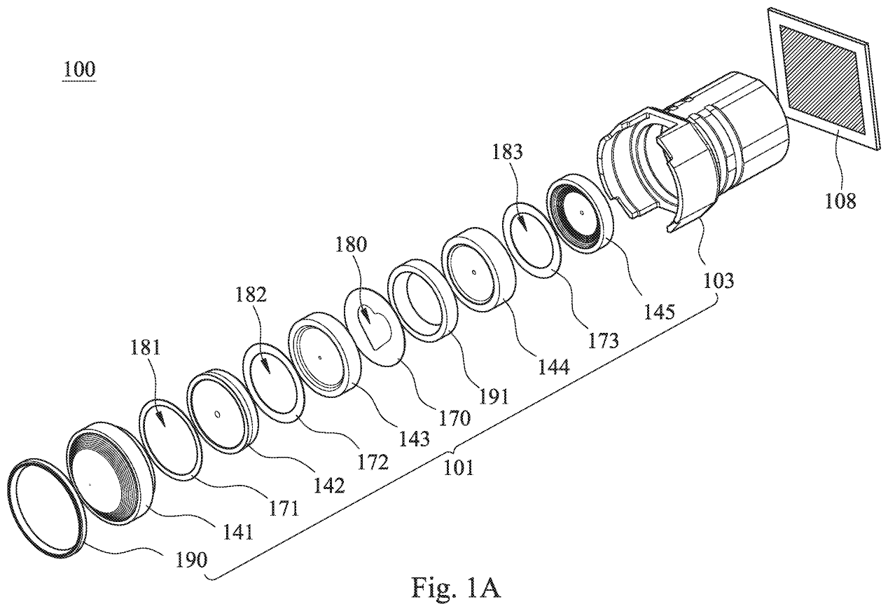

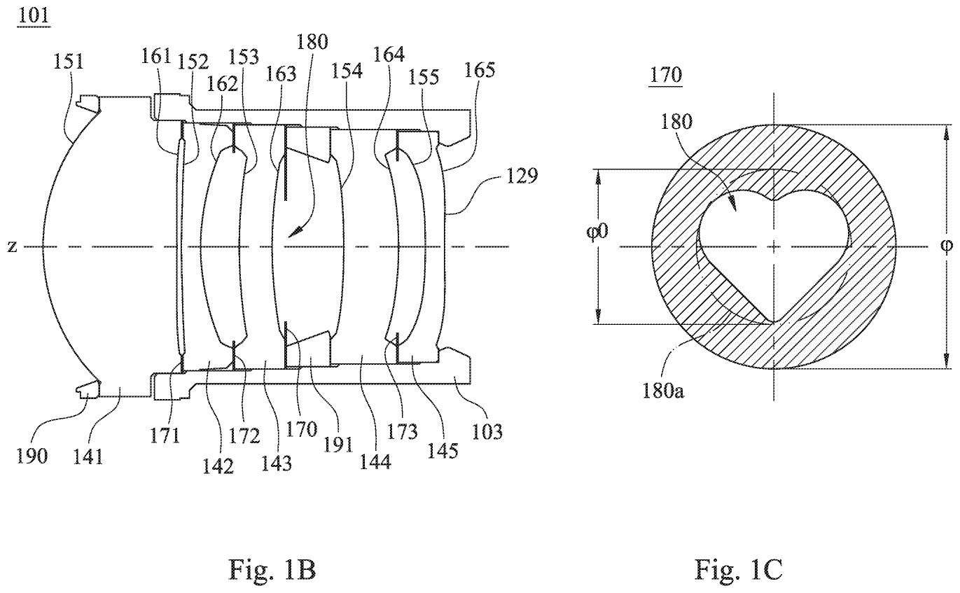

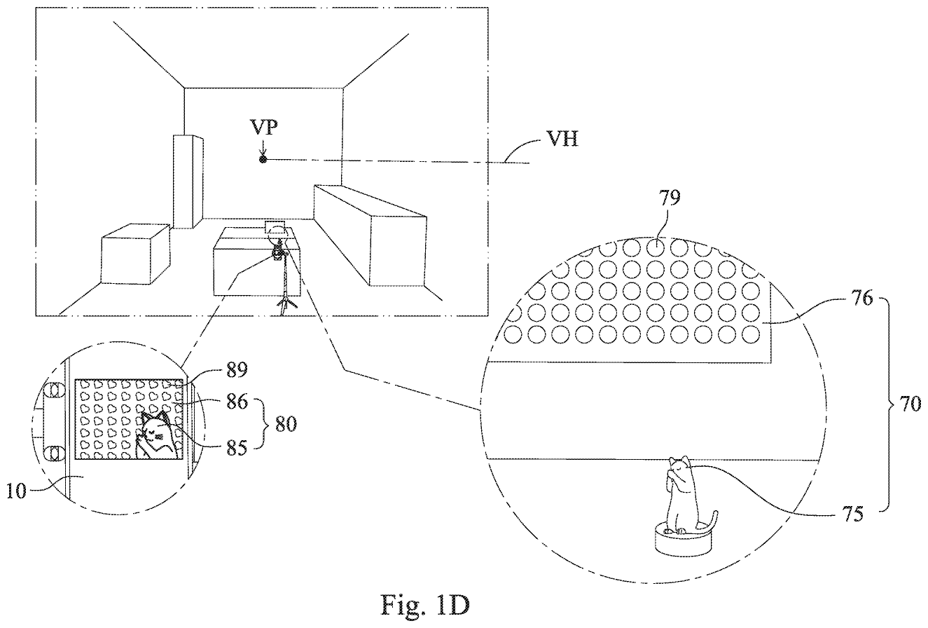

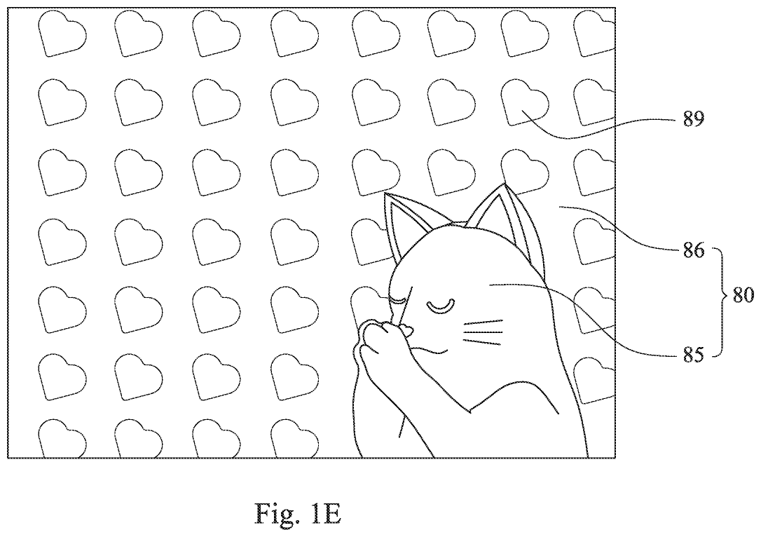

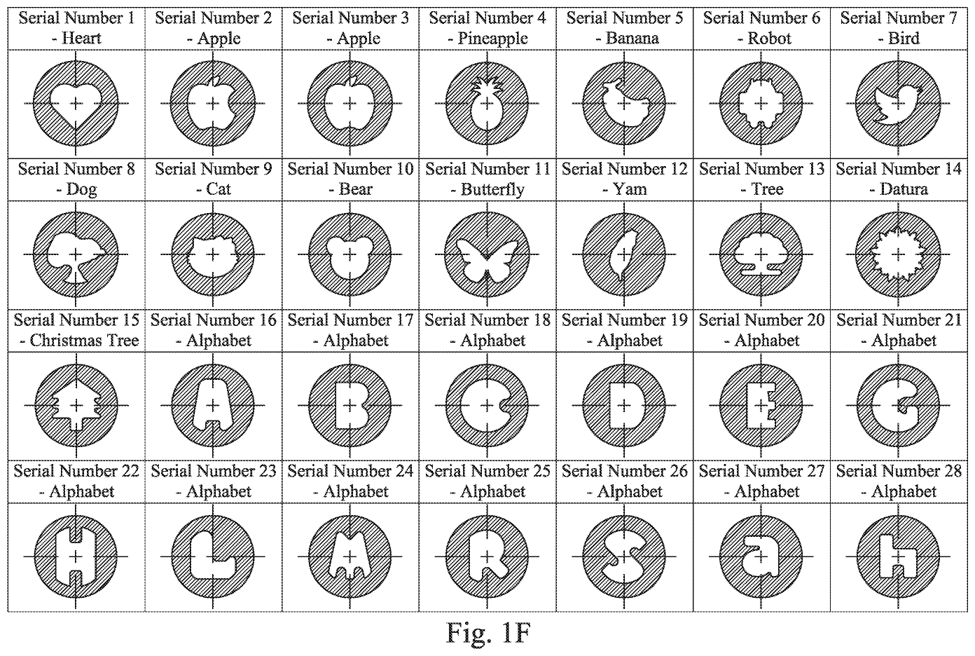

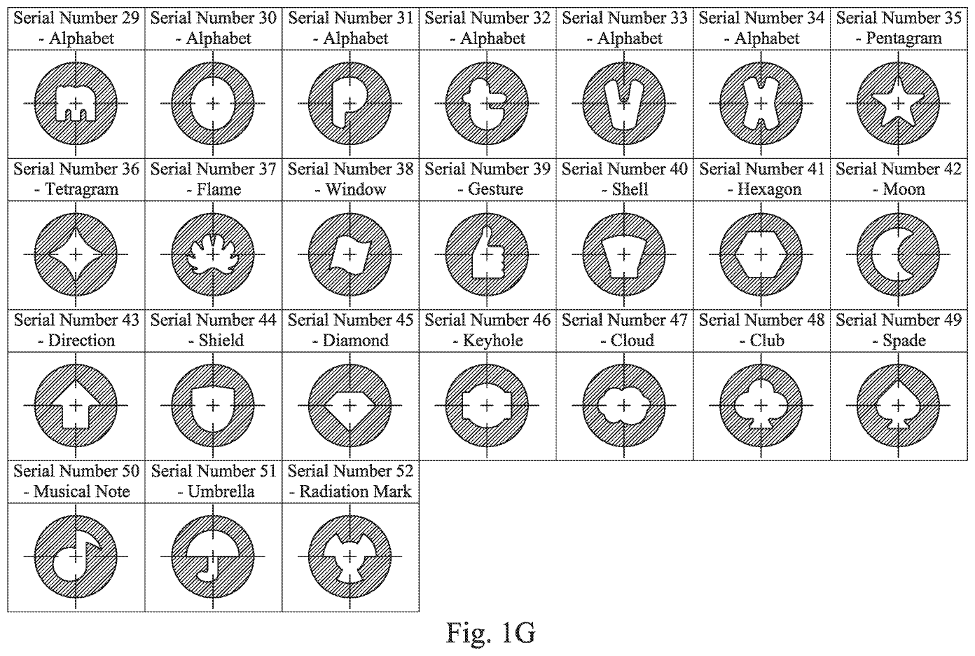

FIG. 1A is an exploded view of a camera module 100 according to a 1st embodiment of the present disclosure. FIG. 1B is a schematic view of an imaging lens assembly 101 of the camera module 100 according to the 1st embodiment. FIG. 1C is a schematic view of a first light blocking sheet 170 of the camera module 100 according to the 1st embodiment, wherein FIG. 1C is also a plan view of the first light blocking sheet 170 observed from an object side or an image side of the imaging lens assembly 101. In FIGS. 1A to 1C, the camera module 100 includes the imaging lens assembly 101 and an image sensor 108, an image 80 is formed on the image sensor 108 via the imaging lens assembly 101, and the image sensor 108 is disposed on the image side of the imaging lens assembly 101. Moreover, the camera module 100 can further include a prism (not shown in FIGS. 1A and 1B) disposed on the object side of the imaging lens assembly 101.

The imaging lens assembly 101 includes a lens barrel 103, a plurality of plastic lens elements 141, 142, 143, 144, 145 and the first light blocking sheet 170. The plastic lens elements 141, 142, 143, 144, 145 are disposed in the lens barrel 103. The first light blocking sheet 170 is disposed in the lens barrel 103 and has a non-circular opening 180, a shape of the non-circular opening 180 is non-circular. According to the 1st embodiment in FIG. 1C, the shape of the non-circular opening 180 is heart-shaped.

FIG. 1D is a schematic view of a using state of the camera module 100 according to the 1st embodiment. FIG. 1E is a schematic view of the image 80 captured via the camera module 100 according to the 1st embodiment. In FIGS. 1D and 1E, a portion of the image 80 formed via the imaging lens assembly 101 is a defocused image 86, a shape of at least one portion (i.e. a plurality of first defocused images 89) of the defocused image 86 is non-circular and corresponding to the shape of the non-circular opening 180 of the first light blocking sheet 170. Therefore, a special effect of the image 80 can be achieved via the camera module 100 with shooting effect without additional postproduction of an electronic device 10. Further, by a defocused shooting effect of the non-circular opening 180 designed by the compact first light blocking sheet 170, it is favorable for further promoting photography experience, and reducing specific manufacturing process of light blocking cover.

In FIG. 1D, the electronic device 10 can be a smart phone and includes the camera module 100 according to the 1st embodiment of the present disclosure. In the using state of the electronic device 10 and the camera module 100 thereof as shown in FIG. 1D, a vision horizon (VH) and a vanishing point (VP) are as shown in FIG. 1 D. An imaged object 70 includes a focusing imaged object 75 and a defocusing imaged object 76, wherein the focusing imaged object 75 is a head of a doll, and the defocusing imaged object 76 is a plane and located on a defocus location of the imaging lens assembly 101 behind the focusing imaged object 75. That is, the defocusing imaged object 76 is located beyond a depth of focus. The defocusing imaged object 76 includes a plurality of first defocusing imaged objects 79 and a gap between each two of the first defocusing imaged objects 79, and each of the first defocusing imaged objects 79 is circular.

FIGS. 1D and 1E show the image 80 of the imaged object 70 captured via the camera module 100 of the electronic device 10, respectively. Via the imaging lens assembly 101, a light of the imaged object 70 is gathered on the image sensor 108 to form the image 80 (that is, data or a signal of the image 80). The image 80 can be displayed via a screen (its reference numeral is omitted) of the electronic device 10, wherein the shape of the image 80 is not changed by a hardware and a software (that is, postproduction) of the electronic device 10 after captured via the camera module 100. The image 80 includes a focused image 85 and a defocused image 86, wherein the focused image 85 is an image of the focusing imaged object 75, and the defocused image 86 is an image of the defocusing imaged object 76. The defocused image 86 includes a plurality of first defocusing images 89 corresponding to the first defocusing imaged objects 79 and images of gaps between each two of the first defocusing imaged objects 79, respectively. In FIGS. 1D and 1E, a portion of the image 80 formed via the imaging lens assembly 101 is the focused image 85, and a shape of the focused image 85 is the same as a shape of the focusing imaged object 75. Another portion of the image 80 formed via the imaging lens assembly 101 is the defocused image 86, and a portion of the defocused image 86 is the aforementioned plurality of the first defocusing images 89. A shape of each of the first defocusing images 89 is non-circular and corresponding to or the same as (that is, the same as the shape and a proportion of the non-circular opening 180) the shape of the non-circular opening 180 (that is, heart-shaped) of the first light blocking sheet 170. That is, the shape of each of the first defocusing images 89 is not corresponding to or the same as the shape of the first defocusing objects 79 (that is, circular). Actually, the shape of each of the first defocusing images 89 is probably not sharp as the schematic views of FIGS. 1D and 1E. Therefore, the camera module 100 has a shooting effect via the first light blocking sheet 170 with the non-circular opening 180. That is, the camera module 100 has the defocused shooting effect corresponding to the shape of the non-circular opening 180, and a special effect of the image 80 can be achieved without extra postproduction of the electronic device 10. Therefore, it is favorable for further promoting a shooting experience of the electronic device 10 and the camera module 100 thereof. According to the camera module 100 of the present disclosure, a photo with special effect can be captured without a retouching software, and the photo without the retouching software is more natural, more aesthetic and more authentic than a photo dealt with the retouching software.

For further example (not shown), when an imaged object is an outdoor scene, a first defocusing imaged object of a defocusing imaged object of the imaged object is a circular moon or a street light. When the imaged object is captured via the camera module 100 of the 1st embodiment, a shape of a first defocusing image (that is, a shape of the moon or the street light) is non-circular and corresponding to or the same as the shape of the non-circular opening 180 (that is, heart-shaped) of the first light blocking sheet 170, and the shape of the first defocusing image is not corresponding to or the same as a shape (circular) of the first defocusing imaged object. When the defocusing imaged object includes a defocusing imaged object with a non-circular shape, such as a square signboard, a leaf and etc., and a shape of a defocused image corresponding to a shape of the square signboard is corresponding to or the same as (that is, slightly different from a shape and a proportion of the non-circular opening 180) the shape of the non-circular opening 180 of the first light blocking sheet 170. That is, the shape of the defocused image is between the shape of the square signboard and the shape of the non-circular opening 180 (that is, heart-shaped). Moreover, a shape of the defocused image corresponding to the leaf is corresponding to or the same as the shape of the non-circular opening 180 of the first light blocking sheet 170. That is, the shape of the defocused image is between the shape of the leaf and the shape of the non-circular opening 180 (that is, heart-shaped). Moreover, the defocusing imaged object can be a shape indoor or a shape outdoor according to a shooting demand of the camera module 100. That is, the defocusing imaged object can be an object which a light source or a brightness of the object is obviously different from surroundings, but the present disclosure is not limited thereto. Furthermore, the shape of the defocused image can probably be not the same as the shape of the defocusing imaged object but the same as or corresponding to the shape of the non-circular opening 180. Also, a clearness of the shape of the defocused image is probably corresponding to a brightness or relative brightness of the defocusing imaged object.

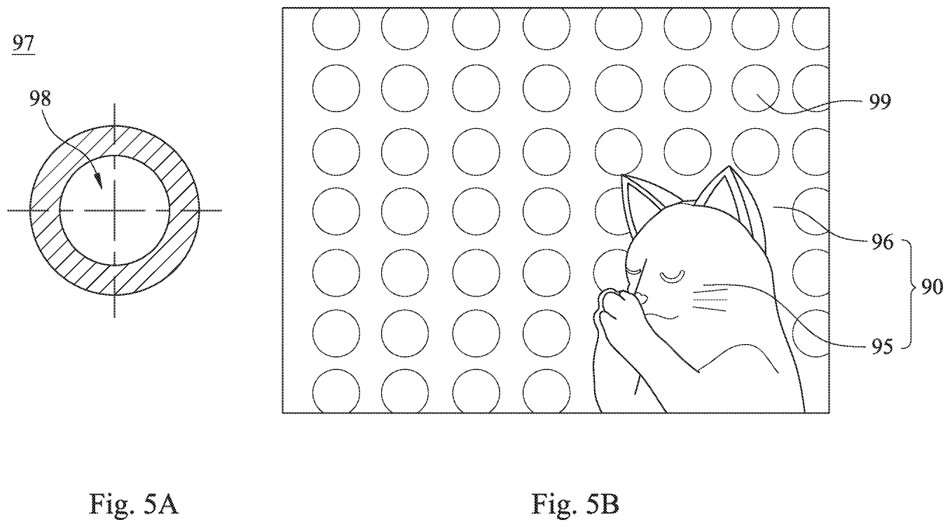

FIG. 5A is a schematic view of a light blocking sheet 97 of a camera module (not shown) of prior art. FIG. 5B is a schematic view of an image 90 captured via the camera module of prior art. In FIGS. 5A and 5B, the camera module of prior art includes an imaging lens assembly and an image sensor, wherein an image is formed on the image sensor via the imaging lens assembly, and the image sensor is disposed on an image side of the imaging lens assembly. The imaging lens assembly includes a lens barrel, a plurality of plastic lens elements and the light blocking sheet 97. The plastic lens elements are disposed in the lens barrel, and the light blocking sheet 97 is disposed in the lens barrel and has an inner opening 98, wherein the inner opening 98 is circular.

The schematic view of a using state applied via the camera module of prior art is shown as FIG. 1D. That is, the imaged object 70 (in FIG. 1 D, the electronic device 10 is substituted via the electronic device including the camera module of prior art) is captured via the camera module of prior art. The imaged object 70 includes the focusing imaged object 75 and the defocusing imaged object 76, and the defocusing imaged object 76 includes the aforementioned plurality of first defocusing imaged objects 79 and the gaps between each two of the first defocusing imaged objects 79.

A light of the imaged object 70 is gathered on the image sensor via the imaging lens assembly of the camera module of prior art to form the image 90, the image 90 is captured via the camera module of prior art without additional hardware and software of the electronic device to change a shape of the image 90. The image 90 includes a focused image 95 and a defocused image 96, wherein the focused image 95 is an image of the focusing imaged object 75, and the defocused image 96 is an image of the defocusing imaged object 76. The defocused image 96 includes each of first defocusing images 99 corresponding to each of the first defocusing imaged objects 79 and an image corresponding to the gaps between each two of the first defocusing imaged objects 79. In FIG. 5A, a portion of the image 90 formed via the imaging lens assembly of the camera module of prior art is the focused image 95, and a shape of the focused image 95 is the same as the shape of the focusing imaged object 75. Another portion of the image 90 formed via the imaging lens assembly is the defocused image 96, and the portion of the defocused image 96 is the aforementioned plurality of first defocusing images 99 of prior art. Each shape of the first defocusing images 99 of prior art is corresponding to or the same as the shape (that is, circular) of the first defocusing imaged objects 79. Hence, the image 90 captured via the camera module of prior art is entirely corresponding to or the same as the shape of the focusing imaged object 75 and the shape of the defocusing imaged object 76 no matter what the shape of the focused image 95 and a shape of the defocused image 96 are.

When the image object is the outdoor scene, the defocusing imaged object of the imaged object is the circular moon, the street light, the square signboard, the leaf and etc. The shape of the defocused image is corresponding to or the same as the defocusing imaged object, when the aforementioned imaged object is captured via the camera module of prior art.

In FIGS. 1A to 1C, the imaging lens assembly 101 further includes a plurality of light blocking sheets 171, 172, 173 besides the first light blocking sheet 170. The first light blocking sheet 170 has the non-circular opening 180, and the light blocking sheets 171, 172, 173 have inner openings 181, 182, 183, respectively. The non-circular opening 180 is non-circular, and the inner openings 181, 182, 183 are circular and coaxially arranged along an optical axis z of the imaging lens assembly 101. The inner opening of one of the first light blocking sheet 170 and the light blocking sheets 171, 172, 173 (that is, the first light blocking sheet 170) is the non-circular opening 180, and the non-circular opening 180 is the smallest among the non-circular opening 180 of the first light blocking sheet 170 and each of the inner openings 181, 182, 183 of each of the light blocking sheets 171, 172, 173. Therefore, it is favorable for enhancing the effect of the shape of the non-circular opening 180 transferring to the image 80, and it is also favorable for blocking specific beam. Furthermore, a dimension of the non-circular opening 180 is defined as a diameter φ0 of a maximum circumscribed circle 180a (that is, a virtual circumscribed circle) centered on the optical axis z. In FIG. 1C, the diameter φ0 of the maximum circumscribed circle 180a is 2.4351 mm. The dimension of each of the inner openings 181, 182, 183 is defined as a diameter thereof. In the 1st embodiment, the diameter φ0 of a maximum circumscribed circle 180a of the non-circular opening 180 centered on the optical axis z is smaller than each of the diameters of the inner openings 181, 182, 183. Therefore, the non-circular opening 180 is the smallest among the non-circular opening 180 of the first light blocking sheet 170 and each of the inner openings 181, 182, 183 of each of the light blocking sheets 171, 172, 173.

The first light blocking sheet 170 having the non-circular opening 180 can act as an aperture stop of the imaging lens assembly 101. That is, the first light blocking sheet 170 is used to control an amount of a light reaching the imaging lens assembly 101. Therefore, it is favorable for a special shape of the first defocused images 89 of the image 80 being more corresponding to the shape of the non-circular opening 180, and the amount of the light reaching the imaging lens assembly 101 can be controlled.

In FIG. 1C, when a diameter of the first light blocking sheet 170 is φ, the following condition can be satisfied: 1.0 mm<φ<6.0 mm. Therefore, the first light blocking sheet 170 can be manufactured by a miniaturized processing method with the non-circular opening 180. Furthermore, the possibility of the compact imaging lens assembly 101 is provided, and the specific beam can be efficiently blocked. Moreover, the following condition can be satisfied: 1.0 mm<φ<4.5 mm. In the 1st embodiment, the diameter φ of the first light blocking sheet 170 is 3.830 mm.

FIGS. 1F and 1G are schematic views of the non-circular opening 180 of the first light blocking sheet 170 according to the 1st embodiment. In FIGS. 1F and 1G, the non-circular opening 180 of the first light blocking sheet 170 can be one of heart-shaped, fruit-shaped, robot-shaped, animal-shaped, plant-shaped, alphabet-shaped, star-shaped and sign-shaped. Therefore, the non-circular opening 180 of the first light blocking sheet 170 can be manufactured by a processing method with a special shape, and different special shapes of the non-circular opening 180 can be selected according to users' preferences.

For example, besides heart-shaped according to FIG. 1C and the serial number 1 of FIG. 1F, the shape of the non-circular opening 180 of the first light blocking sheet 170 can be fruit-shaped according to serial numbers 2, 3, 4, 5 of FIG. 1F. According to the serial number 6 of FIG. 1F, the shape of the non-circular opening 180 can be robot-shaped. According to the serial numbers 7, 8, 9, 10, 11 of FIG. 1 F, the shape of the non-circular opening 180 can be animal-shaped. According to the serial numbers 2, 3, 4, 5, 12, 13, 14, 15 of FIG. 1F, the non-circular opening 180 can be plant-shaped. According to the serial numbers 16, 17, 18, 19, 20, 21, 22, 23, 24, 25, 26, 27, 28 of FIG. 1F and the serial numbers 29, 30, 31, 32, 33, 34 of FIG. 1G, the shape of the non-circular opening 180 can be alphabet-shaped. According to the series numbers 35, 36 of FIG. 1G, the shape of the non-circular opening 180 can be star-shaped. According to the series numbers 12, 14 of FIG. 1F and the series numbers 37, 38, 39, 40, 41, 42, 43, 44, 45, 46, 47, 48, 49, 50, 51, 52 of FIG. 1G, the shape of the non-circular opening 180 can be sign-shaped, wherein the sign-shaped non-circular opening 180 can be shown as specific indication purpose or a shape of specific symbol, but the present disclosure is not limited thereof. Furthermore, the shape of the non-circular opening 180 of the first light blocking sheet 170 can be adjusted in dimension, shape position, shape details, etc. from the serial numbers 1 to 52 of FIGS. 1F and 1G as needed. The shape of the non-circular opening 180 of the first light blocking sheet 170 is not limited to the shapes of the serial numbers 1 to 52 of FIGS. 1F and 1G. When the defocusing imaged object is circular, the shape of the defocusing imaged object is corresponding to or the same as the shape of the non-circular opening 180 of the first light blocking sheet 170. When the defocusing imaged object is not circular, the shape of the defocusing imaged object is corresponding to or similar to the shape of the non-circular opening 180 of the first light blocking sheet 170.

When a maximum field of view of the camera module 100 is FOV, the following condition can be satisfied: 5 degrees<FOV≤45 degrees. Therefore, it is favorable for enhancing the effect of the shape of the non-circular opening 180 of the first light blocking sheet 170 transferring to the image 80, and a telephoto function of the imaging lens assembly 101 is provided. When the imaging lens assembly 101 is a telephoto lens, the effect of the shape of the non-circular opening 180 transferring to the image 80 is better. Furthermore, the following condition can be satisfied: 5 degrees<FOV≤30 degrees. In the 1st embodiment, the maximum field of view FOV of the camera module 100 is 19.5 degrees.

In FIG. 1B, the imaging lens assembly 101 includes the plastic lens elements 141, 142, 143, 144, 145 in order from the object side to the image side of the imaging lens assembly 101, and the plastic lens elements 141, 142, 143, 144, 145 include object-side surfaces 151, 152, 153, 154, 155 facing the object side of the imaging lens assembly 101, respectively. The plastic lens elements 141, 142, 143, 144, 145 include image-side surfaces 161, 162, 163, 164, 165 facing the image side of the imaging lens assembly 101, respectively. An optical effective area of at least one surface of the object-side surfaces 151, 152, 153, 154, 155 and the image-side surfaces 161, 162, 163, 164, 165 of the plastic lens elements 141, 142, 143, 144, 145 can be aspheric. For example, the optical effective area (entire or a portion) of the image-side surface 165 of the plastic lens element 145 is aspheric. Not only the optical effective area of the image-side surface 165 is aspheric, but the optical effective area of the object-side surfaces 151, 152, 153, 154, 155 and the optical effective area of the image-side surfaces 161, 162, 163, 164, 165 of the plastic lens elements 141, 142, 143, 144, 145 can be aspheric. Therefore, it is favorable for decreasing an optical aberration of the imaging lens assembly 101, and applicable to the imaging lens assembly 101 with high specification. Moreover, it is favorable for decreasing a deformation of the shape of the non-circular opening 180 transferring to the image 80 and promoting the special effect. Furthermore, the imaging lens assembly 101 further includes the first light blocking sheet 170, the light blocking sheets 171, 172, 173, a spacing ring 191 and a retainer 190, wherein the first light blocking sheet 170 is disposed between the plastic lens element 143 and the spacing ring 191.

The optical effective area of the image-side surface 165 among the object-side surfaces 151, 152, 153, 154, 155 and the image-side surfaces 161, 162, 163, 164, 165 of the plastic lens elements 141, 142, 143, 144, 145 can include an inflection point 129. The inflection point 129 is a junction point of a curvature variation between positive and negative. Not only the optical effective area of the image-side surface 165 can include the inflection point 129, but the object-side surfaces 151, 152, 153, 154, 155 and the image-side surfaces 161, 162, 163, 164, 165 of the plastic lens elements 141, 142, 143, 144, 145 can include inflection points. Therefore, it is favorable for decreasing the optical aberration of the imaging lens assembly 101 to obtain better imaging quality, and it is favorable for decreasing the deformation of the shape of the non-circular opening 180 transferring to the image 80 to promote the special effect.

### 2nd Embodiment

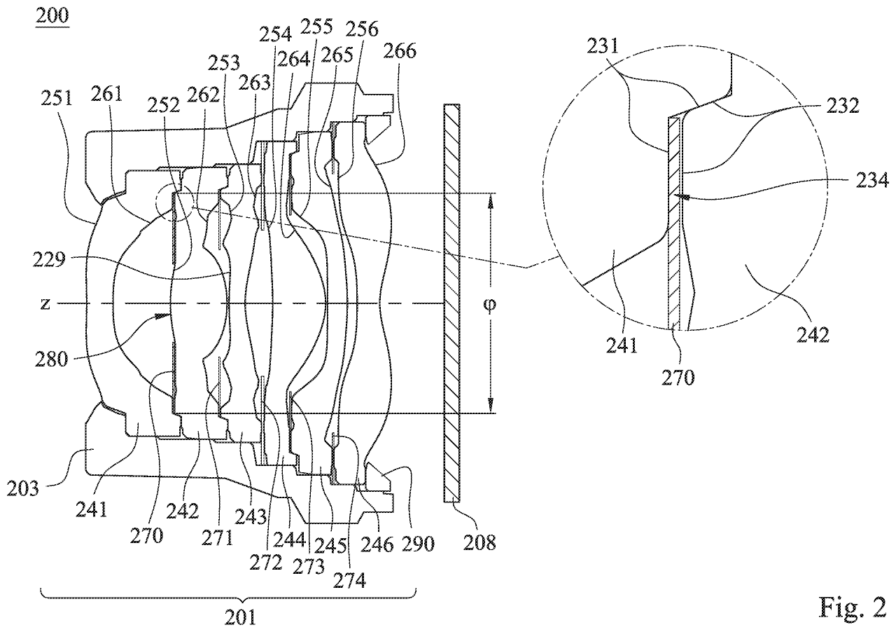

FIG. 2 is a schematic view of a camera module 200 according to a 2nd embodiment of the present disclosure. In FIG. 2, the camera module 200 includes an imaging lens assembly 201 and an image sensor 208, an image is formed on the image sensor 208 via the imaging lens assembly 201, and the image sensor 208 is disposed on an image side of the imaging lens assembly 201.

The imaging lens assembly 201 includes a lens barrel 203, a plurality of plastic lens elements 241, 242, 243, 244, 245, 246 and a first light blocking sheet 270. The plastic lens elements 241, 242, 243, 244, 245, 246 are disposed in the lens barrel 203. The first light blocking sheet 270 is disposed in the lens barrel 203 and has a non-circular opening 280, and a shape of the non-circular opening 280 is non-circular. For example, the shape of the non-circular opening 280 can be the shape of the serial numbers 1 to 52 of FIGS. 1F and 1G, but is not limited thereof. A portion of the image formed via the imaging lens assembly 201 is a defocused image, and a shape of at least one portion of the defocused image is non-circular and corresponding to the shape of the non-circular opening 280 of the first light blocking sheet 270.

The imaging lens assembly 201 further includes a plurality of light blocking sheets 271, 272, 273, 274 besides the first light blocking sheet 270. The first light blocking sheet 270 has the non-circular opening 280, and the light blocking sheets 271, 272, 273, 274 have inner openings (the reference numerals are omitted), respectively. The non-circular opening 280 is non-circular, and the inner openings are circular and coaxially arranged along an optical axis z of the imaging lens assembly 201. The inner opening of one of the first light blocking sheet 270 and the light blocking sheets 271, 272, 273, 274 (that is, the first light blocking sheet 270) is the non-circular opening 280, and the non-circular opening 280 is the smallest among the non-circular opening 280 of the first light blocking sheet 270 and each of the inner openings of each of the light blocking sheets 271, 272, 273, 274.

In the 2nd embodiment, the first light blocking sheet 270 having the non-circular opening 280 acts as an aperture stop of the imaging lens assembly 201. A diameter φ of the first light blocking sheet 270 is 3.40 mm, and a maximum field of view FOV of the camera module 200 is 115.6 degrees.

The imaging lens assembly 201 includes the plastic lens elements 241, 242, 243, 244, 245, 246 in order from an object side to the image side of the imaging lens assembly 201, and the plastic lens elements 241, 242, 243, 244, 245, 246 include object-side surfaces 251, 252, 253, 254, 255, 256 facing the object side of the imaging lens assembly 201, respectively. The plastic lens elements 241, 242, 243, 244, 245, 246 include image-side surfaces 261, 262, 263, 264, 265, 266 facing the image side of the imaging lens assembly 201, respectively. An optical effective area of at least one surface of the object-side surfaces 251, 252, 253, 254, 255, 256 and the image-side surfaces 261, 262, 263, 264, 265, 266 of the plastic lens elements 241, 242, 243, 244, 245, 246 is aspheric. For example, the optical effective area (entire or a portion) of the object-side surface 253 of the plastic lens element 243 is aspheric. Not only the optical effective area of the object-side surface 253 is aspheric, but the optical effective area of the object-side surfaces 251, 252, 253, 254, 255, 256 and the optical effective area of the image-side surfaces 261, 262, 263, 264, 265, 266 of the plastic lens elements 241, 242, 243, 244, 245, 246 can be aspheric. Furthermore, the imaging lens assembly 201 further includes the first light blocking sheet 270, the light blocking sheets 271, 272, 273, 274, and a retainer 290, wherein the first light blocking sheet 270 is disposed between the plastic lens elements 241 and 242.

The optical effective area of the object-side surface 253 among the object-side surfaces 251, 252, 253, 254, 255, 256 and the image-side surfaces 261, 262, 263, 264, 265, 266 of the plastic lens elements 241, 242, 243, 244, 245, 246 can include an inflection point 229. Not only the optical effective area of the object-side surface 253 can include the inflection point 229, but the object-side surfaces 251, 252, 253, 254, 255, 256 and the image-side surfaces 261, 262, 263, 264, 265, 266 of the plastic lens elements 241, 242, 243, 244, 245, 246 can include inflection points.

The first light blocking sheet 270 is disposed between the plastic lens elements 241 and 242 among the plastic lens elements 241, 242, 243, 244, 245, 246, and the first light blocking sheet 270 and the plastic lens elements 241, 242 are coaxially arranged along the optical axis z of the imaging lens assembly 201. The first light blocking sheet 270 is disposed in the imaging lens assembly 201. Therefore, an appearance of the camera module 200 is not affected via the imaging lens assembly 201, and the specific beam can be more precisely blocked.

One of the plastic lens elements 241 and 242 (that is, the plastic element 241) is adjacently disposed on an object side of the first light blocking sheet 270 and includes a first engagement surface 231, and another one of the plastic lens elements 241 and 242 (that is, the plastic element 242) is adjacently disposed on an image side of the first light blocking sheet 270 and includes a second engagement surface 232. The first engagement surface 231 and the second engagement surface 232 are corresponding to and engaged to each other, an accommodating space 234 is formed between the first engagement surface 231 and the second engagement surface 232, and the first light blocking sheet 270 is disposed in the accommodating space 234. Therefore, it is favorable for the first light blocking sheet 270 and the plastic lens elements 241 and 242 alignedly arranged along the optical axis z of the imaging lens assembly 201 to provide better imaging quality and stability of the compact imaging lens assembly 201.

In FIG. 2, the first engagement surface 231 includes at least one surface vertical to the optical axis z and at least one surface inclined to the optical axis z (the reference numerals are omitted), and the second engagement surface 232 includes at least one surface vertical to the optical axis z and at least one surface inclined to the optical axis z (the reference numerals are omitted). The surface inclined to the optical axis z of the first engagement surface 231 and the surface inclined to the optical axis z of the second engagement surface 232 contact each other to engage, and the surface vertical to the optical axis z of the first engagement surface 231 and the surface vertical to the optical axis z of the second engagement surface 232 do not contact each other to form the accommodating space 234.

### 3rd Embodiment

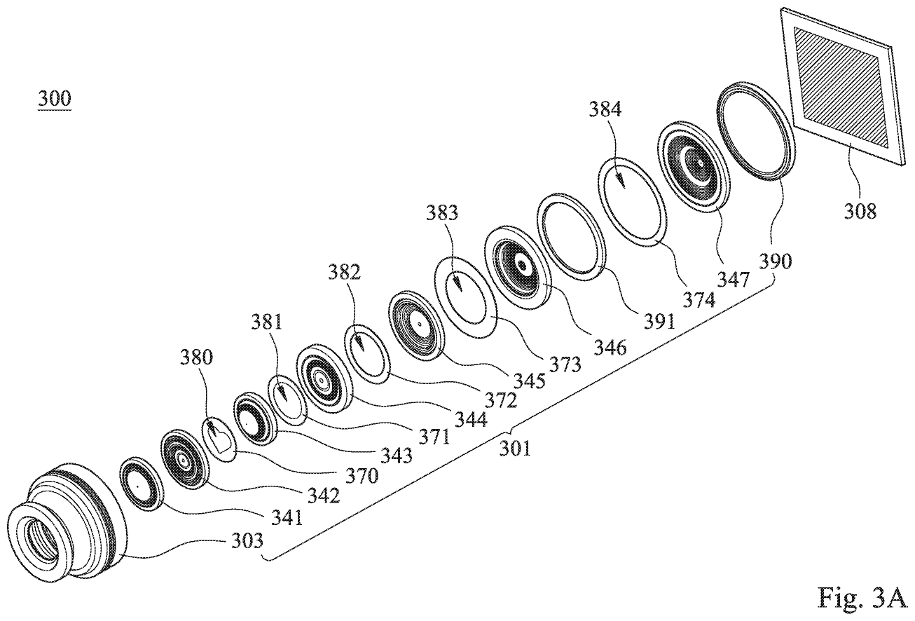

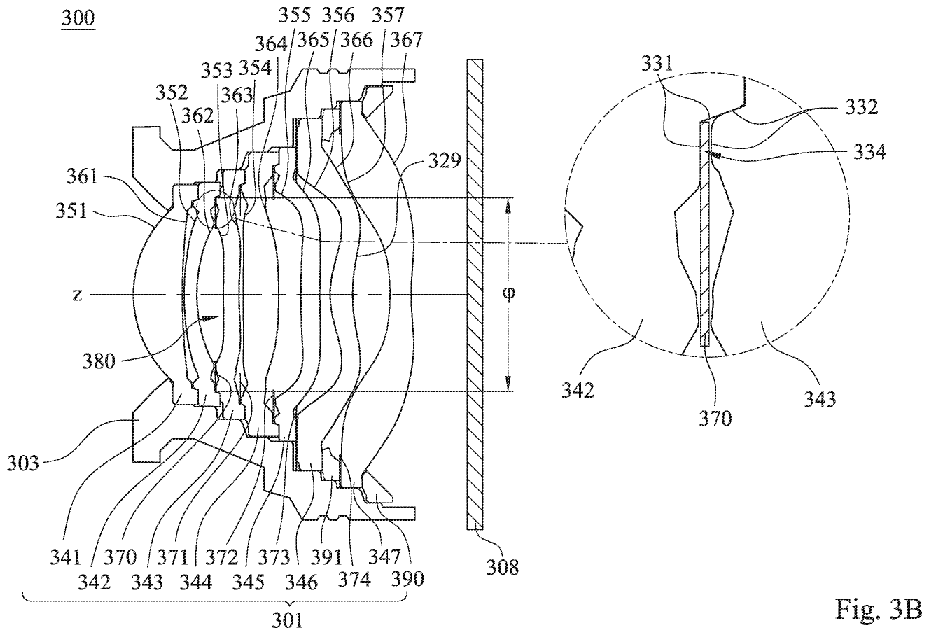

FIG. 3A is an exploded view of a camera module 300 according to a 3rd embodiment of the present disclosure. FIG. 3B is a schematic view of the camera module 300 according to the 3rd embodiment. In FIGS. 3A and 3B, the camera module 300 includes an imaging lens assembly 301 and an image sensor 308, an image is formed on the image sensor 308 via the imaging lens assembly 301, and the image sensor 308 is disposed on an image side of the imaging lens assembly 301.

The imaging lens assembly 301 includes a lens barrel 303, a plurality of plastic lens elements 341, 342, 343, 344, 345, 346, 347 and a first light blocking sheet 370. The plastic lens elements 341, 342, 343, 344, 345, 346, 347 are disposed in the lens barrel 303. The first light blocking sheet 370 is disposed in the lens barrel 303 and has a non-circular opening 380, and a shape of the non-circular opening 380 is non-circular. For example, the shape of the non-circular opening 380 can be the shape of the serial numbers 1 to 52 of FIGS. 1F and 1G, but is not limited thereof. A portion of the image formed via the imaging lens assembly 301 is a defocused image, and a shape of at least one portion of the defocused image is non-circular and corresponding to the shape of the non-circular opening 380 of the first light blocking sheet 370.

The imaging lens assembly 301 further includes a plurality of light blocking sheets 371, 372, 373, 374 besides the first light blocking sheet 370. The first light blocking sheet 370 has the non-circular opening 380, and the light blocking sheets 371, 372, 373, 374 have inner openings 381, 382, 383, 384, respectively. The non-circular opening 380 is non-circular, and the inner openings 381, 382, 383, 384 are circular and coaxially arranged along an optical axis z of the imaging lens assembly 301. The inner opening of one of the first light blocking sheet 370 and the light blocking sheets 371, 372, 373, 374 (that is, the first light blocking sheet 370) is the non-circular opening 380, and the non-circular opening 380 is the smallest among the non-circular opening 380 of the first light blocking sheet 370 and each of the inner openings 381, 382, 383, 384 of each of the light blocking sheets 371, 372, 373, 374.

In the 3rd embodiment, the first light blocking sheet 370 having the non-circular opening 380 acts as an aperture stop of the imaging lens assembly 301. A diameter φ of the first light blocking sheet 370 is 3.95 mm, and a maximum field of view FOV of the camera module 300 is 78.1 degrees.

The imaging lens assembly 301 includes the plastic lens elements 341, 342, 343, 344, 345, 346, 347 in order from an object side to the image side of the imaging lens assembly 301, and the plastic lens elements 341, 342, 343, 344, 345, 346, 347 include object-side surfaces 351, 352, 353, 354, 355, 356, 357 facing the object side of the imaging lens assembly 301, respectively. The plastic lens elements 341, 342, 343, 344, 345, 346, 347 include image-side surfaces 361, 362, 363, 364, 365, 366, 367 facing the image side of the imaging lens assembly 301, respectively. An optical effective area of at least one surface of the object-side surfaces 351, 352, 353, 354, 355, 356, 357 and the image-side surfaces 361, 362, 363, 364, 365, 366, 367 of the plastic lens elements 341, 342, 343, 344, 345, 346, 347 is aspheric. For example, the optical effective area (entire or a portion) of the image-side surface 366 of the plastic lens element 346 is aspheric. Not only the optical effective area of the image-side surface 366 is aspheric, but the optical effective area of the object-side surfaces 351, 352, 353, 354, 355, 356, 357 and the optical effective area of the image-side surfaces 361, 362, 363, 364, 365, 367 of the plastic lens elements 341, 342, 343, 344, 345, 346, 347 can be aspheric. Furthermore, the imaging lens assembly 301 further includes the first light blocking sheet 370, the light blocking sheets 371, 372, 373, 374, a spacing ring 391 and a retainer 390, wherein the first light blocking sheet 370 is disposed between the plastic lens elements 342 and 343.

The optical effective area of the image-side surface 366 among the object-side surfaces 351, 352, 353, 354, 355, 356, 357 and the image-side surfaces 361, 362, 363, 364, 365, 366, 367 of the plastic lens elements 341, 342, 343, 344, 345, 346, 347 can include an inflection point 329. Not only the optical effective area of the image-side surface 366 can include the inflection point 329, but the object-side surfaces 351, 352, 353, 354, 355, 356, 357 and the image-side surfaces 361, 362, 363, 364, 365, 367 of the plastic lens elements 341, 342, 343, 344, 345, 346, 347 can include inflection points.

The first light blocking sheet 370 is disposed between the plastic lens elements 342 and 343 among the plastic lens elements 341, 342, 343, 344, 345, 346, 347, and the first light blocking sheet 370 and the plastic lens elements 342, 343 are coaxially arranged along the optical axis z of the imaging lens assembly 301.

One of the plastic lens elements 342 and 343 (that is, the plastic element 342) is adjacently disposed on an object side of the first light blocking sheet 370 and includes a first engagement surface 331, and another one of the plastic lens elements 342 and 343 (that is, the plastic element 343) is adjacently disposed on an image side of the first light blocking sheet 370 and includes a second engagement surface 332. The first engagement surface 331 and the second engagement surface 332 are corresponding to and engaged to each other, an accommodating space 334 is formed between the first engagement surface 331 and the second engagement surface 332, and the first light blocking sheet 370 is disposed in the accommodating space 334.

In FIG. 3B, the first engagement surface 331 includes at least one surface vertical to the optical axis z and at least one surface inclined to the optical axis z (the reference numerals are omitted), and the second engagement surface 332 includes at least one surface vertical to the optical axis z and at least one surface inclined to the optical axis z (the reference numerals are omitted). The surface inclined to the optical axis z of the first engagement surface 331 and the surface inclined to the optical axis z of the second engagement surface 332 contact each other to engage, and the surface vertical to the optical axis z of the first engagement surface 331 and the surface vertical to the optical axis z of the second engagement surface 332 do not contact each other to form the accommodating space 334.

### 4th Embodiment

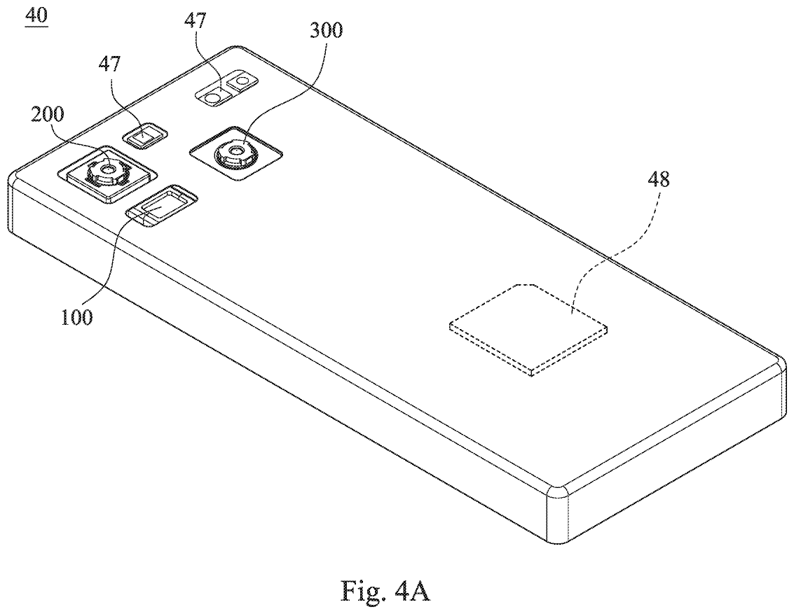

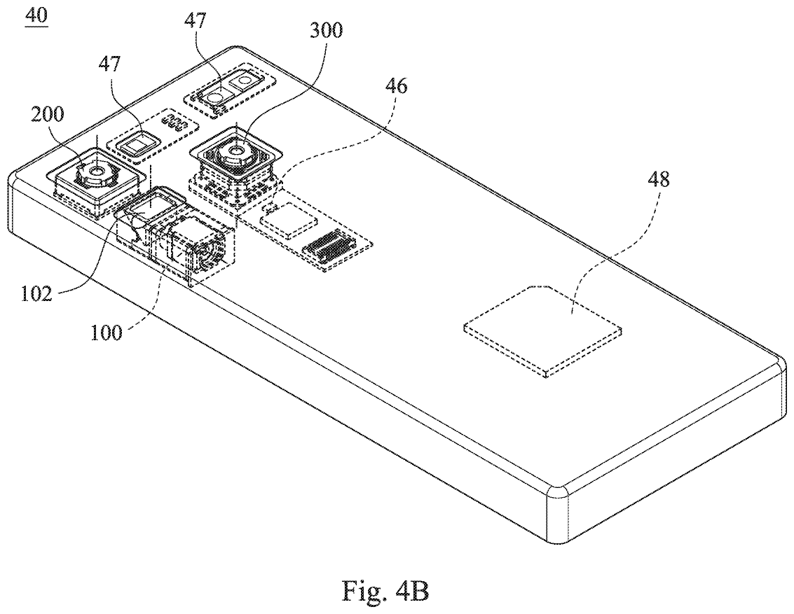

FIG. 4A is a schematic view of an electronic device 40 according to a 4th embodiment of the present disclosure. FIG. 4B is another schematic view of the electronic device 40 according to the 4th embodiment. In FIGS. 4A and 4B, the electronic device 40 is a smart phone having three lens elements and includes the camera module 100 of the 1st embodiment, the camera module 200 of the 2nd embodiment and the camera module 300 of the 3rd embodiment. The camera modules 100, 200, 300 are disposed toward a same side of the electronic device 40. Another electronic device can be an electronic device having at least two lens elements, such as a smart phone having two lens elements, a smart phone have four lens elements, a tablet having two lens elements, etc. according to the embodiments (not shown) of the present disclosure.

According to the camera module 100 of the electronic device 40, the camera module 100 includes the imaging lens assembly 101 and the image sensor 108, an image is formed on the image sensor 108 via the imaging lens assembly 101, and the image sensor 108 is disposed on the image side of the imaging lens assembly 101. The imaging lens assembly 101 includes the lens barrel 103, the plurality of plastic lens elements 141, 142, 143, 144, 145 and the first light blocking sheet 170. The plastic lens elements 141, 142, 143, 144, 145 are disposed in the lens barrel 103. The first light blocking sheet 170 is disposed in the lens barrel 103 and has the non-circular opening 180. A portion of the image formed via the imaging lens assembly 101 is a defocused image. A shape of at least one portion of the defocused image is non-circular and corresponding to the shape of the non-circular opening 180 of the first light blocking sheet 170. Moreover, the camera module 100 can further include a prism 102 disposed on an object side of the imaging lens assembly 101. Please refer to the statement of the 1st embodiment about other details of the camera module 100.

According to the camera module 200 of the electronic device 40, the camera module 200 includes the imaging lens assembly 201 and the image sensor 208, an image is formed on the image sensor 208 via the imaging lens assembly 201, and the image sensor 208 is disposed on the image side of the imaging lens assembly 201. The imaging lens assembly 201 includes the lens barrel 203, the plurality of plastic lens elements 241, 242, 243, 244, 245, 246 and the first light blocking sheet 270. The plastic lens elements 241, 242, 243, 244, 245, 246 are disposed in the lens barrel 203. The first light blocking sheet 270 is disposed in the lens barrel 203 and has the non-circular opening 280. A portion of the image formed via the imaging lens assembly 201 is a defocused image, and a shape of at least one portion of the defocused image is non-circular and corresponding to the shape of the non-circular opening 280 of the first light blocking sheet 270. Please refer to the statement of the 2nd embodiment about other details of the camera module 200.

According to the camera module 300 of the electronic device 40, the camera module 300 includes the imaging lens assembly 301 and the image sensor 308, an image is formed on the image sensor 308 via the imaging lens assembly 301, and the image sensor 308 is disposed on the image side of the imaging lens assembly 301. The imaging lens assembly 301 includes the lens barrel 303, the plurality of plastic lens elements 341, 342, 343, 344, 345, 346, 347 and the first light blocking sheet 370. The plastic lens elements 341, 342, 343, 344, 345, 346, 347 are disposed in the lens barrel 303. The first light blocking sheet 370 is disposed in the lens barrel 303 and has the non-circular opening 380. A portion of the image formed via the imaging lens assembly 301 is the defocused image, and a shape of at least one portion of the defocused image is non-circular and corresponding to the shape of the non-circular opening 380 of the first light blocking sheet 370. Please refer to the statement of the 3rd embodiment about other details of the camera module 300.

In the 4th embodiment, the electronic device 40 includes two camera modules (that is, two of the camera modules 100, 200, 300), and each of the two camera modules includes each of two imaging lens assemblies, wherein at least one of the two imaging lens assemblies is the camera modules 101, 201, 301 of the camera modules 100, 200, 300, respectively, according to the present disclosure. It is favorable for providing the electronic device 40 equipped with the camera module with the shooting effect rather than additional postproduction via the electronic device 40 to achieve the special effect of the image.

According to the 1st embodiment to the 3rd embodiment, the non-circular opening 180 is the smallest among the non-circular opening 180 of the first light blocking sheet 170 and each of the inner openings 181, 182, 183 of each of the light blocking sheets 171, 172, 173, the non-circular opening 280 is the smallest among the non-circular opening 280 of the first light blocking sheet 270 and each of the inner openings of each of the light blocking sheets 271, 272, 273, 274, and the non-circular opening 380 is the smallest among the non-circular opening 380 of the first light blocking sheet 370 and each of the inner openings 381, 382, 383, 384 of each of the light blocking sheets 371, 372, 373, 374. In the 4th embodiment, the aforementioned condition can be satisfied via the non-circular opening of the electronic device 40. It is favorable for enhancing the effect of at least one of the shapes of the non-circular openings 180, 280, 380 transferring to the image, and it is also favorable for blocking specific beam.

When a maximum field of view of the camera module 100 of the electronic device 40 is FOV, the following condition can be satisfied: 5 degrees<FOV≤45 degrees. Therefore, it is favorable for enhancing the effect of the shape of the non-circular opening 180 of the first light blocking sheet 170 transferring to the image, and a telephoto function of the imaging lens assembly 101 is provided. When the imaging lens assembly 101 is a telephoto lens element, the effect of the shape of the non-circular opening 180 transferring to the image 80 is better. Furthermore, the following condition can be satisfied: 5 degrees<FOV≤30 degrees. In the 4th embodiment, the condition of the maximum field of view FOV can only be satisfied via the camera module 100 among the camera modules 100, 200, 300.

The difference between the two maximum fields of view of the two camera modules of the electronic device 40 can be at least 30 degrees. For example, the difference between the maximum field of view FOV of the camera module 100 (19.5 degrees) and the maximum field of view FOV of the camera module 200 (115.6 degrees) is 96.1 degrees. Therefore, the defocused image can be transferred to a shape corresponding to each of the non-circular openings 180, 280 of each of the first light blocking sheets 170, 270 acting as the aperture stop (the non-circular opening can be disposed near the aperture stop in the present disclosure). A clear indication can be provided by switching between the image of the telephoto lens element (that is, the camera module 100) and the image of a short-focus lens element (that is, the camera module 200) of the electronic device 40.

In detail, the camera module 100 of the electronic device 40 is the telephoto lens element, and the maximum field of view FOV thereof is less than or equal to 45 degrees. The camera module 200 of the electronic device 40 is a wide angle lens element, and the maximum field of view FOV thereof is more than 90 degrees. The maximum field of view FOV of the camera module 300 of the electronic device 40 (78.1 degrees) is between the maximum field of view FOV of the camera module 100 and the maximum field of view FOV of the camera module 200. Furthermore, the maximum field of view FOV of the two camera modules of the electronic device according to the present disclosure is not limited by the values disclosed by the 4th embodiment, and the disposition of the two camera modules is not limited by the positions disclosed by FIGS. 4A and 4B.

Among the plastic lens elements 141 to 145 of the imaging lens assembly 101, the plastic lens elements 241 to 246 of the imaging lens assembly 201 and the plastic lens assembly 341 to 347 of the imaging lens assembly 301 of the electronic device 40, at least one surface of the optical effective portion of the object-side surface and the image-side surface of at least one plastic lens element can be aspheric. According to the 1st embodiment to the 3rd embodiment, the optical effective area of the image-side surface 165 of the imaging lens assembly 101, the optical effective area of the object-side surface 253 of the imaging lens assembly 201 and the optical effective area of the image-side surface 366 of the imaging lens assembly 301 are aspheric. Therefore, it is favorable for decreasing the optical aberration of the imaging lens assemblies 101, 201, 301 to applicable for the electronic device 40 with high specification. Further, it is favorable for decreasing the deformation of the shape of the non-circular openings 180, 280, 380 transferring to the image to promote the special effect

Among the plastic lens elements 141 to 145 of the imaging lens assembly 101, the plastic lens elements 241 to 246 of the imaging lens assembly 201 and the plastic lens assembly 341 to 347 of the imaging lens assembly 301 of the electronic device 40, the optical effective area of at least one surface of the object-side surface and the image-side surface of the at least one of the plastic lens elements can include the inflection point. According to the 1st embodiment to the 3rd embodiment, the optical effective area of the image-side surface 165 of the imaging lens assembly 101 includes the inflection point 129, the optical effective area of the object-side surface 253 of the imaging lens assembly 201 includes the inflection point 229, and the optical effective area of the image-side surface 366 of the imaging lens assembly 301 includes the inflection point 329. Therefore, it is favorable for decreasing the optical aberration of the imaging lens assemblies 101, 201, 301 to obtain better imaging quality. Further, it is favorable for decreasing the deformation of the shape of the non-circular openings 180, 280, 380 transferring to the image to promote the special effect.

According to the camera specification, at least one of the camera modules 100, 200, 300 can further include an auto-focusing mechanism and an optical anti-shake mechanism (the reference numeral is omitted), and the electronic device 40 can further include at least one auxiliary optical component 47 and at least one sensing component 46. The auxiliary optical component 47 can be a flash module for compensating color temperature, an infrared distance measurement component, a laser focus module, etc. The sensing component 46 can have functions for sensing physical momentum and kinetic energy, such as an accelerator, a gyroscope, a Hall Effect Element, to sense shaking or jitters applied by hands of the user or external environments. Accordingly, the auto-focusing mechanism and the optical anti-shake mechanism are disposed on at least one of the camera modules 100, 200, 300 to achieve the superior image quality.

In the shooting process of the electronic device 40, one to three images can be captured via the camera modules 100, 200, 300, and the effect of zooming, fine image and etc. can be achieved via a processor disposed on the electronic device 40, such as an image signal processor (ISP) 48.

Furthermore, the electronic device 40 can further include, but not be limited to, a wireless communication unit, a control unit, a storage unit, a random access memory (RAM), a read-only memory (ROM), or the combination thereof.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A camera module, comprising an imaging lens assembly and an image sensor, an image formed on the image sensor via the imaging lens assembly, the image sensor disposed on an image side of the imaging lens assembly, and the imaging lens assembly comprising:
a lens barrel;
a plurality of plastic lens elements disposed in the lens barrel; and
a first light blocking sheet disposed in the lens barrel and having a non-circular opening;
wherein a portion of the image formed via the imaging lens assembly is a defocused image, a shape of at least one portion of the defocused image is non-circular and corresponding to a shape of the non-circular opening of the first light blocking sheet.

2. The camera module of claim 1, wherein the imaging lens assembly comprises a plurality of light blocking sheets, each of the light blocking sheets has an inner opening, one of the light blocking sheets is the first light blocking sheet which has the inner opening being the non-circular opening, and the non-circular opening is a smallest inner opening of the inner openings of the light blocking sheets.

3. The camera module of claim 2, wherein the first light blocking sheet having the non-circular opening is an aperture stop of the imaging lens assembly.

4. The camera module of claim 1, wherein an outer diameter of the first light blocking sheet is φ, and the following condition is satisfied:
1.0 mm<φ<6.0 mm.

5. The camera module of claim 1, wherein the shape of the non-circular opening of the first light blocking sheet is one of heart-shaped, fruit-shaped, robot-shaped, animal-shaped, plant-shaped, alphabet-shaped, star-shaped and sign-shaped.

6. The camera module of claim 5, wherein an outer diameter of the first light blocking sheet is φ, and the following condition is satisfied:
1.0 mm<φ<4.5 mm.

7. The camera module of claim 1, wherein the first light blocking sheet is disposed between two of the plastic lens elements, and the first light blocking sheet and the two plastic lens elements are coaxially arranged.

8. The camera module of claim 7, wherein one of the two plastic lens elements is adjacently disposed on an object side of the first light blocking sheet and comprises a first engagement surface, another one of the two plastic lens elements is adjacently disposed on an image side of the first light blocking sheet and comprises a second engagement surface, the first engagement surface and the second engagement surface are corresponding and engaged to each other, an accommodating space is formed between the first engagement surface and the second engagement surface, and the first light blocking sheet is disposed in the accommodating space.

9. An electronic device, comprising two camera modules, the two camera modules disposed towards a same side of the electronic device, each of the camera modules comprising an imaging lens assembly and an image sensor, an image formed on the image sensor via the imaging lens assembly of each of the camera modules, the image sensor disposed on an image side of the imaging lens assembly of each of the camera modules, and at least one of the two imaging lens assemblies comprising:
a lens barrel;
a plurality of plastic lens elements disposed in the lens barrel; and
a first light blocking sheet disposed in the lens barrel and having a non-circular opening;
wherein a portion of the image formed via the at least one of the two imaging lens assemblies is a defocused image, a shape of at least one portion of the defocused image is non-circular and corresponding to a shape of the non-circular opening of the first light blocking sheet.

10. The electronic device of claim 9, wherein the at least one of the two imaging lens assemblies comprises a plurality of light blocking sheets, each of the light blocking sheets has an inner opening, one of the light blocking sheets is the first light blocking sheet which has the inner opening being the non-circular opening, and the non-circular opening is a smallest inner opening of the inner openings of the light blocking sheets.

11. The electronic device of claim 10, wherein a maximum field of view of the camera module with the at least one of the two imaging lens assemblies is FOV, and the following condition is satisfied:
5 degrees<FOV≤45 degrees.

12. The electronic device of claim 9, wherein a maximum field of view of the camera module with at least one of the two imaging lens assemblies is FOV, and the following condition is satisfied:
5 degrees<FOV≤30 degrees.

13. The electronic device of claim 10, wherein an optical effective area of at least one surface of an object-side surface and an image-side surface of at least one of the plastic lens elements of the at least one of the two imaging lens assemblies is aspheric.

14. The electronic device of claim 13, wherein the optical effective area of the at least one surface comprises an inflection point.

15. The electronic device of claim 9, wherein a difference between two maximum fields of view of the two camera modules is at least 30 degrees.
